(19) United States
(12) Patent Application Publication
(10) Pub. No.: US 2012/0138434 A1
(43) Pub. Date: Jun. 7, 2012

(54) CONVEYOR BELT FOR A BELT CONVEYOR AND METHOD FOR THE PRODUCTION THEREOF

(75) Inventor: HERBERT TRIEB, LOCHAU (AT)

(73) Assignee: INNOVA PATENT GMBH, WOLFURT (AT)

(21) Appl. No.: 13/303,441

(22) Filed: Nov. 23, 2011

(30) Foreign Application Priority Data
Dec. 1, 2010 (AT) A 1977/2010

(51) Int. Cl. B65G 15/36; B32B 38/00

(52) U.S. Cl. 198/847; 156/91

(57) ABSTRACT

A conveyor belt for a belt conveyor is made of rubber or a rubber-like plastic and is reinforced by steel cables extending in the longitudinal direction of the conveyor belt and running at least approximately parallel to one another. The conveyor belt is formed of portions which are connected one to another by vulcanization. The mutually prolonging steel cables located in successive portions are, at least in the majority, spliced together.

### CROSS-REFERENCE TO RELATED APPLICATION

This application claims the priority, under 35 U.S.C. §119, of Austrian application A1997/2010, filed Dec. 1, 2010; the prior application is herewith incorporated by reference in its entirety.

### BACKGROUND OF THE INVENTION

### Field of the Invention

The present invention relates to a conveyor belt for a belt conveyor, which conveyor belt is made of rubber or a rubber-like plastic and is reinforced by steel cables extending in the longitudinal direction of the conveyor belt and running at least approximately parallel to one another. The conveyor belt is made up of mutually connected portions which are connected one to another by vulcanization.

The present invention further relates to a method for producing such a conveyor belt.

Since belt conveyors can have lengths of any size, this is also true of the conveyor belts located therein. Conveyor belts, in particular also because they are configured with reinforcements consisting of steel cables, can be produced and transported only in limited lengths due to the high weight. For this reason, there is a requirement to produce the conveyor belts necessary for belt conveyors in portions, to transport these to those sites at which the belt conveyors are to be built and to there connect the individual portions into self-contained conveyor belts.

The connection of the individual portions of a conveyor belt is realized by removing the rubber material at the mutually facing ends of the portions, whereby the steel cables located in the ends of the portions of the conveyor belt are exposed, by joining together the ends of a first part of the steel cables of the successive portions, whereupon they prolong one another and butt against one another, and by arranging the end regions of a second part of the steel cables side by side, whereupon the end regions of the second part of the steel cables of successive portions overlap. Subsequently the connection of the two successive portions of the conveyor belt is completed by the vulcanization of rubber plates and rubber material.

In order to ensure the necessary dynamic tensile strength of a conveyor belt made up of portions, it is known to divide the steel cables, in the regions of the connection of two portions, into several groups, the ends of which are located at a distance apart. Thus the steel cables are divided, for example, into three groups having ends located at a distance apart in the longitudinal direction. The steel cables of two groups, which end at approximately equal distances apart in the longitudinal direction of the conveyor belt, are here prolonged by steel cables which butt against these, and alongside these steel cables are provided further steel cables, which extend beyond the butt joints and which are not prolonged by any abutting steel cables, but instead overlap with the end regions of adjacent steel cables. Such a connection type is referred to as three-stage. In the case of a plurality of butt joints which are mutually offset in the longitudinal direction of the conveyor belt, such a connection is referred to as multi-stage.

This known connection of portions of a conveyor belt does not therefore meet the operational requirements, however, since the overlaps of end regions of the steel cables give rise to very high shearing stresses in the conveyor belt, which shearing stresses are increased by the fact that in these regions, in relation to the other regions, the steel reinforcement component is increased and the rubber material component reduced, so that in these regions the elasticity of the conveyor belt and its dynamic tensile strength are diminished. During operation, therefore, the first cracks and fractures can appear in these regions of the conveyor belt.

From cable railway technology, it is known to connect steel cables made of steel wires one to another by splicing. At the ends of the two mutually adjoining cable lengths, for example, the individual strands of the steel cables are here provided with different lengths, the individual strands of one of the two cable lengths being successively inserted into the other cable length, instead of a cable core located in the center thereof. The strands of the first cable length are hereby prolonged by the strands of the adjoining cable length. Since, due to the helical path of the individual strands, high inward acting radial forces are generated by the load placed upon the steel cable, such high radial compression forces are exerted upon those ends of the individual strands which are respectively located in the center of one cable length that the adjoining ends of the two cable lengths are connected one to another sufficiently well that the tensile forces transmitted by the steel cable are absorbed by these connections.

In splicings of this type, it is necessary that the individual strands can perform slight mutual displacements in the longitudinal direction of the steel cable. This displaceability of the individual strands is aided by the fact that the cable lengths are provided with lubricants, in particular lubricating greases. Due to lubricants, the flexural rigidity of the steel cables is also reduced and, furthermore, the steel cables are protected against corrosion and abrasion. By contrast, in conveyor belts which are made of rubber or rubber-like plastics materials, when two successive portions are connected by vulcanization, it is necessary to keep these completely free from lubricants, since otherwise a vulcanization which conforms to requirements is not feasible. For this reason, in the connection of portions of conveyor belts consisting of rubber or rubber-like materials and reinforced by steel cables, the previous practice has been to refrain from connecting the steel cables one to another by splicings known from cable railway technology.

### SUMMARY OF THE INVENTION

It is accordingly an object of the invention to provide a conveyor belt for a belt conveyor and a method for the production thereof which overcome the above-mentioned disadvantages of the prior art methods and devices of this general type.

With the foregoing and other objects in view there is provided, in accordance with the invention a conveyor belt for a belt conveyor. The conveyor belt includes portions formed from rubber or a rubber-like plastic and reinforced by steel cables extending in a longitudinal direction of the conveyor belt and running at least approximately parallel to one another. The portions are connected one to another by vulcanization and mutually prolonging steel cables disposed in the successive portions are, at least in a majority, spliced together.

The present invention is based on the recognition that, in the connection of portions of conveyor belts reinforced by steel cables, the steel cables can be spliced together insofar as this splicing is realized with the avoidance of lubricants.

The above-described drawbacks attached to the known conveyor belts are avoided according to the invention by virtue of the fact that the mutually prolonging steel cables located in the successive portions are, at least in the majority, spliced together. Preferably, all mutually prolonging steel cables are spliced together.

As a result of splicings, on the one hand those shearing stresses which, with the previously known conveyor belts in which the successive steel cables are arranged side by side and in mutual overlap in the regions of the connections, are generated in the intervening rubber regions are largely avoided, while, on the other hand, a large increase in the steel component in the regions of the connections, whereby the elasticity of the conveyor belt is heavily reduced and the conveyor belt is prone to fracture in these regions, is also avoided.

The splicings are realized with the avoidance of lubricants.

Since, in conveyor belts, the steel cables provided for their reinforcement are subject to bending stresses only at return drums located, in particular, in the two end stations of the conveyors, which bending stresses, however, are low due to the relatively large diameters, the increased flexural rigidity due to the avoidance of lubricants is insignificant. Since the steel cables are fully penetrated and surrounded by rubber material, furthermore, nor is there a need to protect the steel cables against corrosions and mechanical abrasion by lubricants.

Preferably, the steel cables in two successive, mutually connected portions are connected one to another by a short splice or by a long splice.

According to a method for producing a conveyor belt for a belt conveyor, which conveyor belt consists of rubber or a rubber-like plastics material and is configured with steel cables which reinforce this, the individual portions of the conveyor belt are connected one to another by vulcanization of rubber or rubber-like plastics material. According to the invention the mutually corresponding steel cables of the two successive portions of the conveyor belt, at least in the majority, are spliced together. Preferably, the two portions of the conveyor belt, following the splicing of steel cables, are moved apart, whereby the spliced steel cables are tensioned, in particular to their average tension in the operating state. Whereupon the connection of the two portions one to the other is completed by the vulcanization of rubber or rubber-like plastics material.

Other features which are considered as characteristic for the invention are set forth in the appended claims.

Although the invention is illustrated and described herein as embodied in a conveyor belt for a belt conveyor and a method for the production thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a conveyor belt according to the invention;

FIG. 2 is a diagrammatic, perspective view of an apparatus for connecting free ends of two portions of the conveyor belt according to FIG. 1;

FIG. 3 is a diagrammatic, perspective view of a detail of the conveyor belt according to FIG. 2;

FIG. 4 is a diagrammatic, perspective view of a detail of the conveyor belt according to FIG. 3; and

FIG. 5 is a diagrammatic, perspective view of two spliced together steel cables.

### DETAILED DESCRIPTION OF THE INVENTION

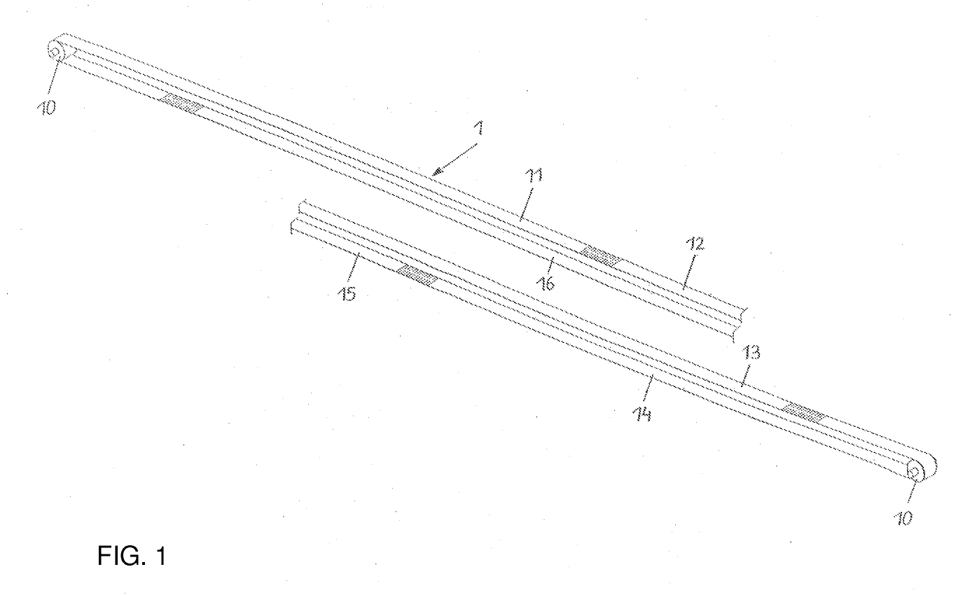

Referring now to the figures of the drawing in detail and first, particularly, to FIG. 1 thereof, there is shown a conveyor represented schematically. The conveyor has a conveyor belt 1, which is self-contained and which at the ends of the conveyor is guided over return drums 10. The conveyor belt 1 of such conveyors, which can extend, for example, over 15 km to 20 km, consists of a multiplicity of portions 11 to 16, which are connected one to another at their ends. The individual portions can have lengths of 200 m to 1000 m. The width of the conveyor belt 1 measures between 0.4 m and 3.5 m. The conveyor belt 1 is formed from rubber or a rubber-like plastic material with a thickness of about 2 cm to about 7 cm and at the same time is reinforced by a multiplicity of mutually adjacent steel cables, extending in a longitudinal direction of the conveyor belt 1, with diameters of, for example, 6 mm to 30 mm.

The steel cables formed of a cable core, which consists of a multiplicity of wires, and of cable strands, which likewise consist of a multiplicity of wires and which helically surround a cable core.

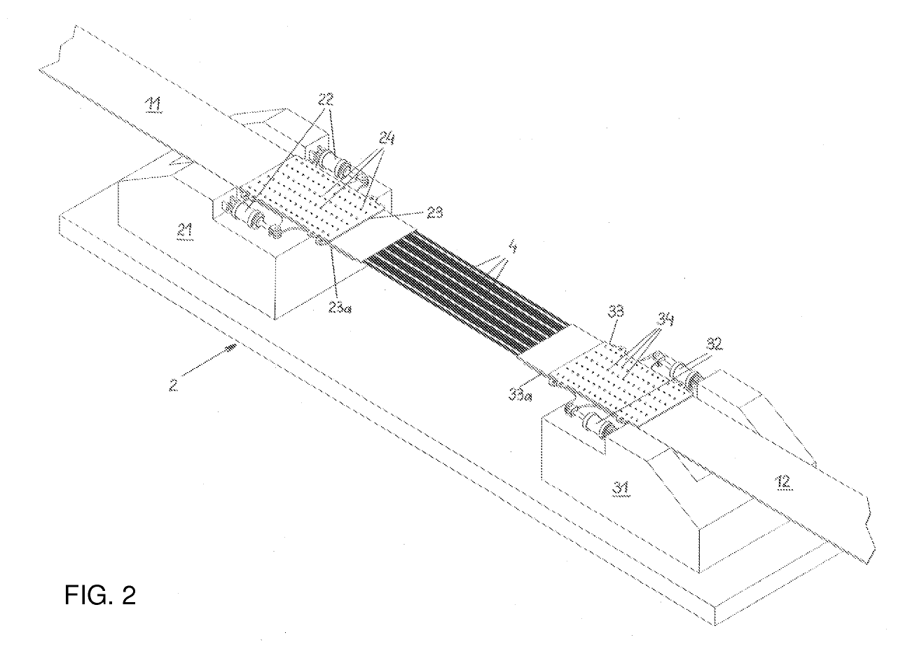

FIG. 2 represents an apparatus 2 which serves to connect two portions 11 and 12 of the conveyor belt 1 one to the other. The apparatus 2 has a first pedestal 21, on which are found two actuating cylinders 22, by which two mutually assigned plates 23 and 23a are adjustable in the longitudinal direction of the conveyor belt 1. The two plates 23 and 23a, which are disposed beneath and above a free end of the portion 11, are tied to each other by a multiplicity of screw bolts 24, which pass through the two plates 23 and 23a and the free end of the portion 11. The free end of the portion 11 can hereby be adjusted in the direction of the conveyor belt 1 by the actuating cylinders 22.

At a distance from the first pedestal 21 is found a second pedestal 31, on which two actuating cylinders 32, by which two mutually assigned plates 33 and 33a are likewise adjustable in the longitudinal direction of the conveyor belt 1, are located. The two plates 33 and 33a, which are likewise disposed beneath and above the free end of the portion 12, are tied together by a multiplicity of screw bolts 34, which pass through the two plates 33 and 33a and the free end of the portion 12. The free end of the portion 12 can hereby be adjusted in the direction of the conveyor belt 1 by the actuating cylinders 32.

In order to connect the free ends of the two portions 11 and 12 of the conveyor belt 1 one to the other, these are moved together by the actuating cylinders 22 and 32 so that they mutually overlap. The ends of the steel cables 4, which are arranged over the width of the conveyor belt 1 in groups of, for example, three steel cables and of eight steel cables, are hereupon exposed by removal of the rubber material surrounding these. After this, the steel cables 4, which respectively prolong one another in the two portions 11 and 12, are connected one to another by a splicing method. According to the existing technical factors, a short splice, a long splice or some other splice can be realized.

It is here of crucial importance in relation to the functioning of the steel cables for reinforcing a conveyor belt, made of rubber or a rubber-like plastics material, for a conveyor that the splice is realized free from any lubricants and that no contamination whatsoever by grease-like substances takes place.

As soon as all mutually corresponding steel cables of the two portions 11 and 12 have been spliced, the two portions 11 and 12 are further connected by vulcanization of the rubber or rubber-like plastics material, wherein the steel cables 4 are penetrated and fully encased by the rubber or rubber-like plastics material. The bores formed by the screw bolts 24 and 34 are likewise closed by vulcanization.

According to a preferred method, the two portions 11 and 12, prior to vulcanization, are moved apart by the two actuating cylinders 22 and 32, whereby the steel cables 4 are stretched, whereupon, in particular, such tension which corresponds to the average tension of the steel cables 4 during operation of the conveyor is imparted to them. In consequence, on the one hand, the steel cables 4 are aligned, and, on the other hand, during operation of the conveyor belt, due to the tension of the steel cables 4, the shearing stresses which are generated in the rubber material enclosing them and by which fractures can be caused are reduced.

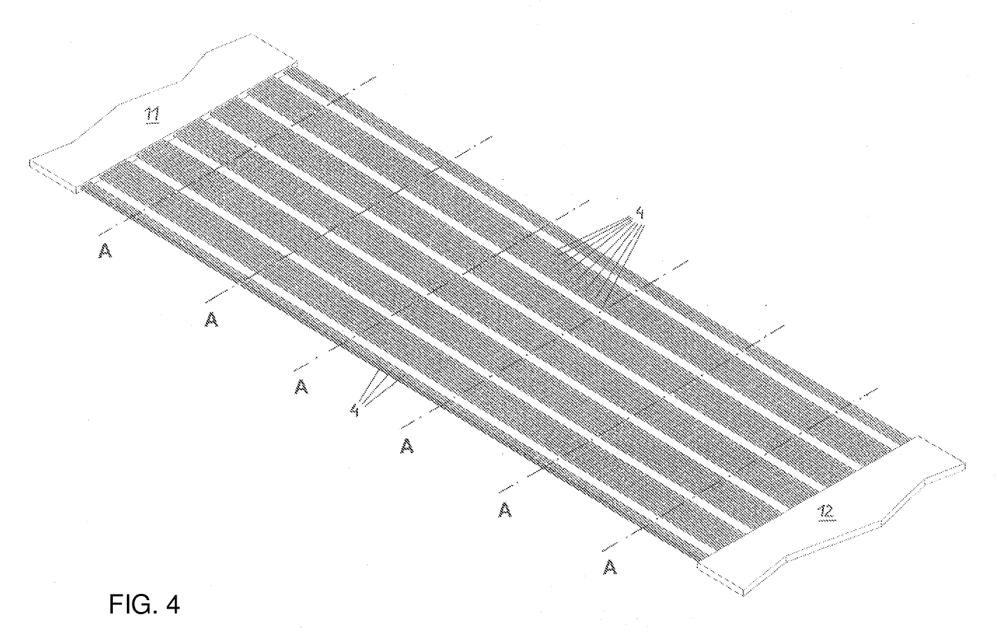

As can be seen from FIG. 3, the steel cables 4 located in a conveyor belt 1 can be combined into several groups, wherein, on the two longitudinal margins of the conveyor belt 1, a group of three directly adjacent steel cables 4, and therebetween five groups of respectively eight directly adjacent steel cables 4, are respectively found. All these steel cables 4 consist of six outer strands and an inner steel core, respectively one of the strands of the spliced together steel cables 4 butting against the adjoining steel cable 4. As a result of these six butt joints located in the regions A, the respective splicing of the steel cables 4 which mutually correspond in the two portions 11 and 12 is realized. The advantages according to the invention are also obtained when the mutually prolonging steel cables 4, in the majority, are spliced together.

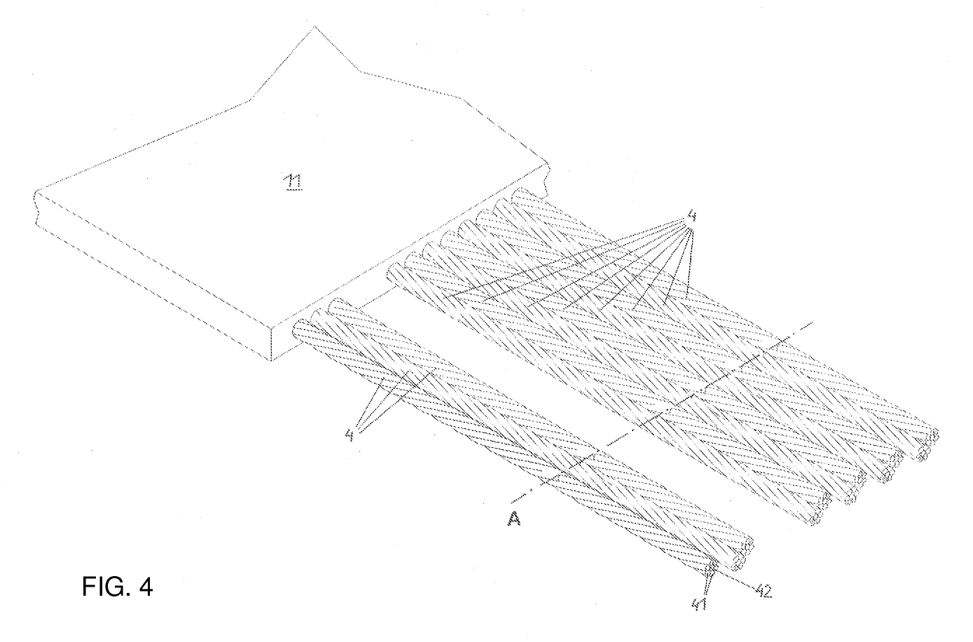

In FIG. 4, a part of the steel cables 4, which consist of six outer strands 41 and an inner steel core 42, and a part of the steel cables 4 in the region A of the butt joints, can be seen.

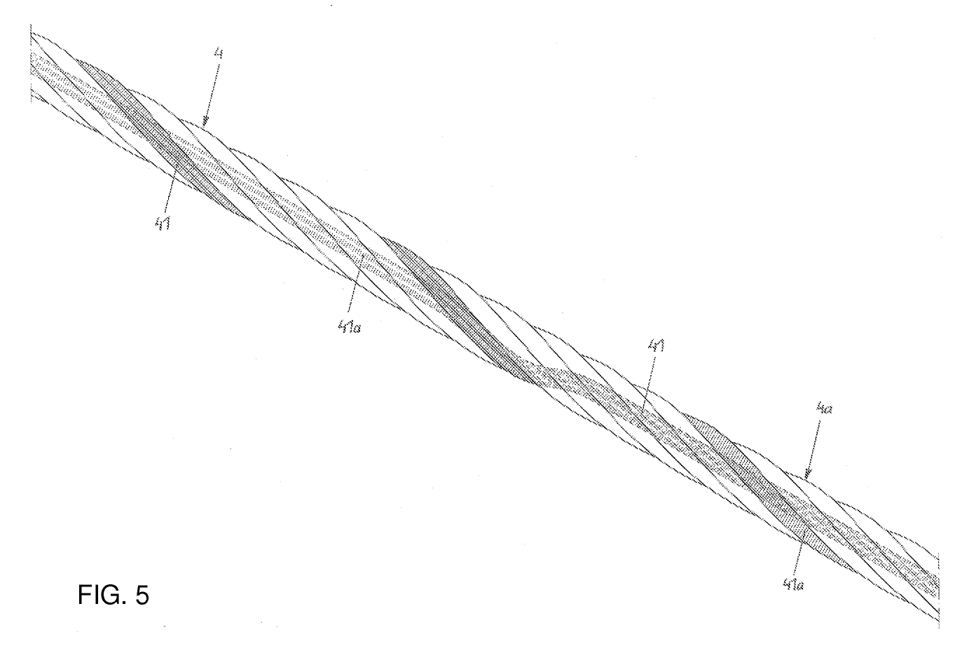

From FIG. 5, one of the butt joints of two spliced together steel cables 4 and 4a can be seen, the free end of the outer strand 41 of the steel cable 4 in the region of the butt joint with the adjoining steel cable 4a, instead of the inner cable core, being inserted in the center of the steel cable 4a, and the free end of the outer strand 41a, instead of the inner cable core, being inserted in the center of the steel cable 4. In the same way, the other strands of the successive steel cables 4 in mutually spaced regions of the tie-up are also respectively inserted into the center of the other steel cable 4a.

As emerges from the above statements and as can be seen, in particular, from FIG. 4, due to the splicings of the steel cables 4 present in conveyor belts, a substantially increased number of steel cables can be provided in the conveyor belts compared to such in which the steel cables are not spliced together, since, due to the splicings, no overlaps of the steel cables are necessary, so that more space is available for the steel cables. Hence, substantially increased tensile forces are transmitted by such conveyor belts, whereby the efficiency of the conveyor belts is greatly increased. In particular, the increased shearing stresses which are generated in the connections between two portions, and thereby induced fractures, are avoided by the splicing of the steel cables.

1. A conveyor belt for a belt conveyor, the conveyor belt comprising:
portions formed from a material selected from the group consisting of rubber and a rubber-like plastic and reinforced by steel cables extending in a longitudinal direction of the conveyor belt and running at least approximately parallel to one another, said portions connected one to another by vulcanization and mutually prolonging steel cables disposed in successive said portions are, at least in a majority, spliced together.

2. The conveyor belt according to claim 1, wherein all of said mutually prolonging steel cables are spliced together.

3. The conveyor belt according to claim 1, wherein a splicing of said steel cables is realized with an avoidance of lubricants.

4. The conveyor belt according to claim 1, wherein said steel cables in two successive, mutually connected portions are connected one to another by a short splice.

5. The conveyor belt according to claim 1, wherein said steel cables in two successive, mutually connected portions are connected one to another by a long splice.

6. A method for producing a conveyor belt for a belt conveyor, the conveyor belt formed of a conveyor material selected from the group consisting of rubber and a rubber-like plastic material and configured with steel cables which reinforce the material, which comprises the steps of:
connecting individual portions of the conveyor belt to one another by vulcanization of the conveyor material; and
splicing together mutually corresponding steel cables of two successive portions of the conveyor belt, at least in a majority.

7. The method according to claim 6, which further comprises moving apart the two successive portions of the conveyor belt, following a splicing of the mutually corresponding steel cables, whereby spliced steel cables are tensioned, whereupon a connection of the two successive portions one to the other is completed by the vulcanization of the conveyor material.

8. The method according to claim 7, which further comprises tensioning the steel cables to their average tension in an operating state.

9. The method according to claim 6, which further comprises splicing together all of the mutually corresponding steel cables of the two successive portions.
